(19) United States
(12) Patent Application Publication
(10) Pub. No.: US 2014/0045086 A1
(43) Pub. Date: Feb. 13, 2014

(54) PRE-ACTIVATION METHOD FOR FUEL CELL STACK

(71) Applicant: HYUNDAI MOTOR COMPANY, Seoul (KR)

(72) Inventors: Hyun Suk Choo, Gyeonggi-do (KR); Jae Hyuk Lee, Gyeonggi-do (KR); Hwan Soo Shin, Gyeonggi-do (KR); Sung Keun Lee, Gyeonggi-do (KR)

(73) Assignee: Hyundai Motor Company, Seoul (KR)

(21) Appl. No.: 13/691,030

(22) Filed: Nov. 30, 2012

(30) Foreign Application Priority Data
Aug. 9, 2012 (KR) 10-2012-0087276

(51) Int. Cl. H01M 8/04; H01M 8/00

(52) U.S. Cl. CPC H01M 8/04223; H01M 8/00
USPC 429/429; 429/535

(57) ABSTRACT

Disclosed is a pre-activation method for a fuel cell stack, which can reduce the amount of hydrogen used and the processing time required during the regular activation process for the fuel cell stack. The disclosure provides, in part, a pre-activation method including: injecting water droplet-containing, humidified hydrogen into a cathode inlet manifold of a fuel cell stack assembled in an assembly process such that the water droplet-containing hydrogen is supplied to a cathode of the fuel cell stack; and sealing and storing the resulting fuel cell stack for a period of time to pre-activate the fuel cell stack.

### CROSS-REFERENCE TO RELATED APPLICATION

This application claims under 35 U.S.C. §119(a) the benefit of Korean Patent Application No. 10-2012-0087276, filed Aug. 9, 2012, the entire contents of which are incorporated herein by reference.

### BACKGROUND

(a) Technical Field

The present invention relates to a pre-activation method for a fuel cell stack. More particularly, it relates to a pre-activation method for a fuel cell stack, which may reduce the amount of hydrogen used and the processing time in a regular activation process of the fuel cell stack.

(b) Background Art

There is an urgent need for the development of environment-friendly vehicles due to increased interest in the effects of environmental pollution and the resulting strict global regulations on carbon dioxide emissions, and thus environment-friendly fuel cell vehicles that can replace internal combustion engine vehicles have attracted much attention.

At present, a polymer electrolyte membrane fuel cell (PEMFC) having high power density is most widely studied fuel cell for use as the main power source for the fuel cell vehicle. The configuration of the fuel cell stack is as follows. A membrane electrode assembly (MEA), a major component, is positioned in the center of each unit cell of the fuel cell stack. The MEA comprises a solid polymer electrolyte membrane, through which hydrogen ions are transported, and catalyst layers including a cathode and an anode, which are coated on both sides of the electrolyte membrane so that hydrogen reacts with oxygen. Moreover, a gas diffusion layer (GDL), a gasket, etc. are sequentially stacked on the outside of the electrolyte membrane, i.e., on the outside where the cathode and the anode are positioned. A separator (also called a bipolar plate) including flow fields, through which reactant gases (hydrogen as a fuel and oxygen or air as an oxidant) are supplied and coolant passes, is positioned on the outside of the GDL. A plurality of unit cells are typically stacked, and an end plate for supporting the unit cells is attached to each of the outermost sides so that the unit cells are arranged and fastened between the end plates, thus constructing a fuel cell stack.

During the operation of each unit cell, a low voltage is maintained and, in order to increase the voltage, several tens to several hundreds of unit cells are arranged in the form of a stack and used as a power plant. In order to enable the assembled fuel cell stack to exhibit normal performance, a stack activation process is performed for the purpose of ensuring a three-phase electrode reaction area, removing impurities from the polymer electrolyte membrane or electrode, and improving the ionic conductivity of the polymer electrolyte membrane. In particular, during the initial operation of the fuel cell stack after assembly, its activity in an electrochemical reaction is reduced, and thus it is necessary to perform the stack activation process so as to ensure normal initial performance. This stack activation process is also called a “pre-conditioning” or “break-in,” and its purpose is to ensure a hydrogen ion channel by fully hydrating electrolyte contained in the electrolyte membrane or electrode.

Conventional methods for the activation of the fuel cell stack include a pulse process comprising a high-current density discharge and shutdown state that is repeated several times to several tens of times, or a process comprising a high-current density output and a vacuum state that is performed as shown in FIG. 1. Such a pulse process typically requires a processing time of about an hour and a half to two hours for a 220-cell submodule. More specifically, a pulse process of discharging a high-current density (of 1.2 or 1.4 A/cm²) for 3 minutes and a process in which pulse discharge is performed in a shutdown state for 5 minutes is typically performed repeatedly about 11 times. Unfortunately, when a fuel cell stack is activated by such a pulse process, both the amount of hydrogen used and the processing time increase, which is problematic. In other words, the existing stack activation process using the pulse discharge in the shutdown state has an advantage of increasing the activation speed by causing a change in the water flow, but has disadvantages of increasing the time required for the activation and significantly increasing the amount of hydrogen consumed.

Moreover, in the conventional stack activation process, in which the process of outputting a high-current density of 1.2 or 1.4 A/cm² for 30 seconds and the process of creating a vacuum state or shutdown state for 2 to 3 minutes are repeated several times as shown in FIG. 1, a high-current output is also used, and thus the amount of hydrogen used and the processing time required are increased. Consequently, as the processing time increases, the stack activation process may become a bottleneck that delays the production of fuel cell stacks due to the limited number of activation devices available during mass production of the fuel cell stacks. Accordingly, there is a need for methods of increasing the efficiency of fuel cell stack activation.

### SUMMARY OF THE DISCLOSURE

The present invention provides methods for reducing the amount of hydrogen used during fuel cell stack activation, as well as for reducing the processing time required for such activation.

In one aspect, the present invention provides a pre-activation method for a fuel cell stack, the method comprising: injecting water droplet-containing, humidified hydrogen into a cathode inlet manifold of a fuel cell stack assembled in an assembly process such that the water droplet-containing hydrogen is supplied to a cathode of the fuel cell stack; and sealing and storing the resulting fuel cell stack.

In an exemplary embodiment, the water droplet-containing, humidified hydrogen (e.g., humidified hydrogen) may be injected into an anode inlet manifold of the fuel cell stack such that the water droplet-containing hydrogen is also supplied to an anode of the fuel cell stack, and then the resulting fuel cell stack may be sealed and stored. In another exemplary embodiment, after the water droplet-containing hydrogen is supplied to the fuel cell stack, the fuel cell stack may be sealed and stored for a day. In still another exemplary embodiment, the fuel cell stack may be sealed and stored at room temperature.

In yet another exemplary embodiment, the step of sealing and storing the fuel cell stack after the step of injecting the hydrogen may be performed prior to an activation process for a 100% activation of the fuel cell stack such that the step of sealing and storing the fuel cell stack is performed as a pretreatment of the fuel cell stack.

In another aspect, the present invention provides a pre-activation method for a fuel cell stack, the method comprising: injecting water droplet-containing, humidified air and water droplet-containing, humidified hydrogen into an anode inlet manifold and a cathode inlet manifold of a fuel cell stack assembled in an assembly process such that the water droplet-containing air and hydrogen are supplied to an anode and a cathode of the fuel cell stack; and sealing and storing the resulting fuel cell stack.

In an exemplary embodiment, the water droplet-containing air and hydrogen may be supplied to the anode and the cathode, and then the resulting fuel cell stack may be sealed and stored for 5 days. In another exemplary embodiment, the fuel cell stack may be sealed and stored at room temperature. In still another exemplary embodiment, the step of sealing and keeping the fuel cell stack after the step of injecting the hydrogen may be performed prior to an activation process for a 100% activation of the fuel cell stack such that the step of sealing and storing the fuel cell stack may be performed as a pretreatment of the fuel cell stack.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated by the accompanying drawings, which are given hereinbelow by way of illustration only, and thus are not limitative of the present invention, and wherein:

FIG. 1 is a diagram showing a voltage distribution in a conventional activation process;

FIG. 2 is a diagram showing a voltage distribution in a pre-activation process in accordance with an exemplary embodiment of the present invention;

FIG. 3 is a diagram showing a voltage distribution in a pre-activation process in accordance with another exemplary embodiment of the present invention; and FIGS. 4 and 5 are diagrams showing voltage distributions in a test example.

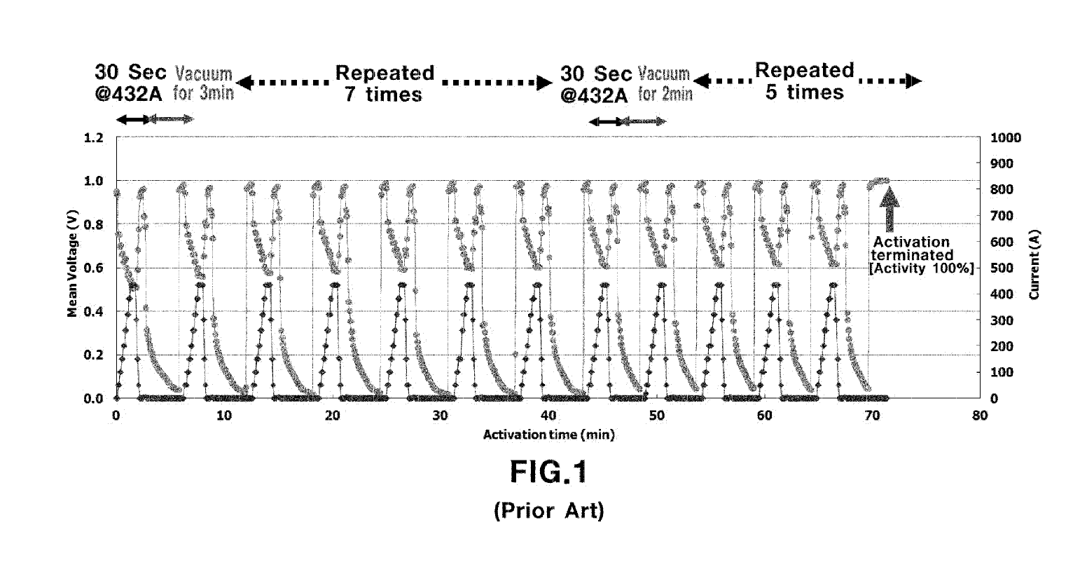

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention provides a method for reducing the amount of hydrogen used and the processing time required during the activation process for a fuel cell stack. In particular, the present invention provides a pre-activation process (e.g., a kind of pretreatment) that may be performed prior to a regular activation process for a 100% activation of a polymer electrolyte membrane fuel cell (PEMFC) that reduces the processing time and the amount of hydrogen consumed in the regular activation process.

According to the techniques herein, the entire activation process of the fuel cell stack may be divided into the pre-activation process of the fuel cell stack proposed by the present invention and the activation process for the 100% activation of the fuel cell performed after the pre-activation process, and the 100% activation process performed after the pre-activation process will be referred to herein as the regular activation process.

The techniques herein provide a new and simpler activation method in terms of the activation mechanism of the electrode membrane. In particular, the techniques herein may make it possible to obtain the pre-activation effect only by injecting droplet-containing hydrogen (e.g., humidified hydrogen) to a cathode of the fuel cell stack, sealing the resulting fuel cell stack, and then storing the fuel cell stack at room temperature without applying a high-power load to the fuel cell stack as is done in the conventional activation process. That is, instead of using the conventional high-power load, a reducing environment may be created in the cathode to effectively remove oxides on the surface of platinum on the cathode and, at the same time, to improve the wetting properties of an electrolyte membrane, thus obtaining the activation effect of the electrolyte membrane. As a result, when the regular activation process is performed after the pre-activation process of the present invention, it is possible to reduce the processing time and the amount of hydrogen consumed for the 100% activation of the fuel cell stack in the regular activation process, and thus the pre-activation process of the present invention may significantly improve the efficiency of mass production of fuel cell stacks.

Next, the pre-activation process of the present invention will be described in more detail.

Conventionally, a desired output is obtained by a process of applying a high-current load several times during the activation of the fuel cell stack. However, in the present invention, it may be possible to obtain the pre-activation effect by only injecting hydrogen to the fuel cell stack, sealing the resulting fuel cell stack, and then storing the fuel cell stack at room temperature without applying a high-current load to the fuel cell stack.

According to the techniques herein, a droplet-containing high temperature hydrogen may be injected into an anode and a cathode of a fuel cell stack assembled in an assembly process, and then the resulting fuel cell stack may be sealed. For example, the fuel cell stack into which hydrogen is injected may be completely sealed by closing the inlet and outlet manifolds of the fuel cell stack, which may then be kept at room temperature for a day. The droplets may be water droplets, and the droplet-containing hydrogen may be produced by humidifying the hydrogen and then supplied to the anode and the cathode, respectively, through the inlet manifold of the fuel cell stack. As such, when the fuel cell stack is sealed and stored at room temperature for a day, an approximately 50% activation of the fuel cell stack may be obtained. Moreover, when a reducing environment is created in the cathode by the hydrogen supplied to the cathode, oxides such as PtOH, PtO, etc. formed on the surface of

Pt catalyst on the cathode may be reduced (dissolved platinum ions are reprecipitated, and thus a vacuum is created in the fuel cell stack), which may facilitate a 50% activation of the fuel cell stack without the high-current output.

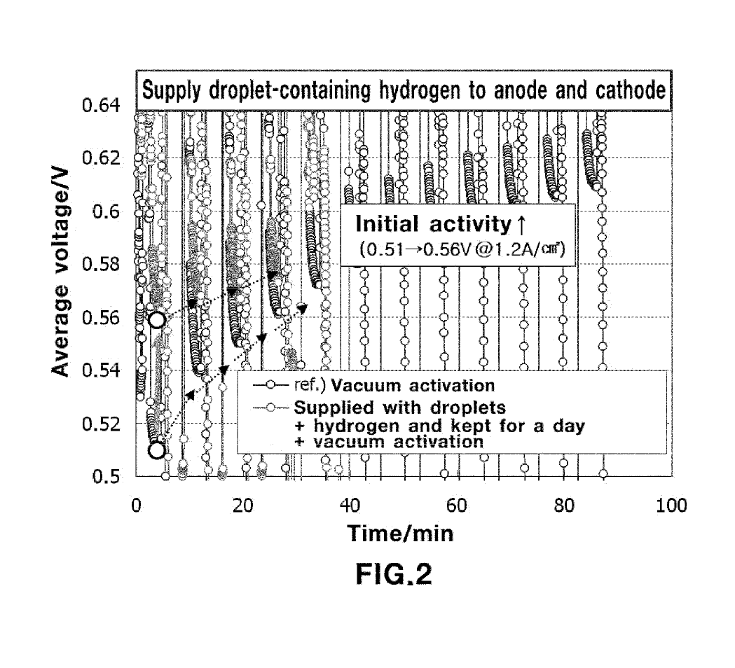

An exemplary voltage distribution over time during the pre-activation process is shown in FIG. 2, which illustrates that when the droplet-containing hydrogen is supplied to the fuel cell stack [“supplied with droplets+hydrogen and kept for a day+vacuum activation”], the initial activation increases (e.g., the voltage increases from 0.51 V to 0.56 V at 1.2 A/cm²) compared with the simple vacuum activation process. Moreover, in another exemplary embodiment of the present invention, droplet-containing air and hydrogen may be supplied to the anode and the cathode of the assembled fuel cell stack, and the resulting fuel cell stack may be sealed and then stored at room temperature for about 5 days. In other words, the droplet-containing air may be supplied to the anode through an anode inlet manifold and, at the same time, the droplet-containing hydrogen may be supplied to the cathode through a cathode inlet manifold such that the air and hydrogen are supplied to the anode and the cathode in the fuel cell stack, respectively, and then the resulting fuel cell stack may be sealed and stored. In this case, the droplet-containing air may be air containing water droplets, like the droplet-containing hydrogen, and the droplet-containing air may be produced by humidifying the air supplied to the anode through the inlet manifold of the fuel cell stack. As such, when the fuel cell stack is sealed and stored at room temperature for 5 days, an approximately 83% activation of the fuel cell stack may be achieved without applying the high-power load.

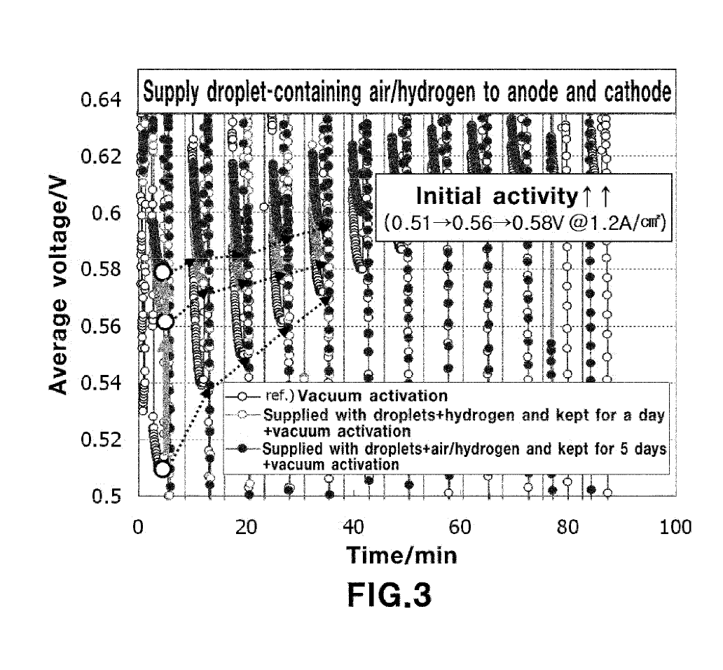

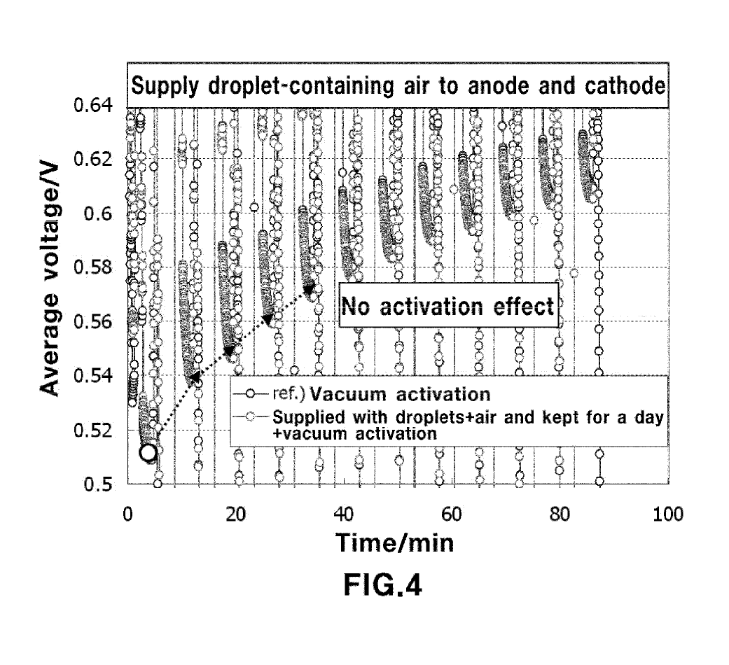

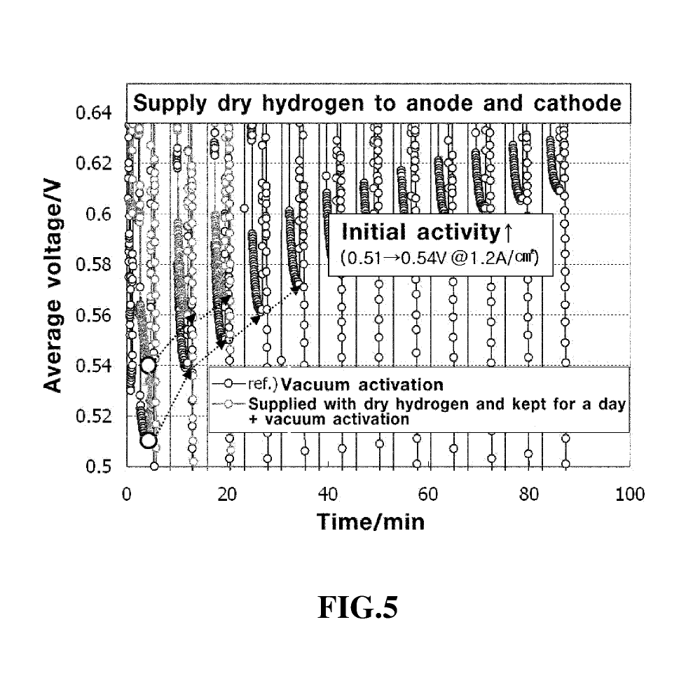

FIG. 3 illustrates the voltage distribution over time in the pre-activation process and shows that when the “droplets+air” and the “droplets+hydrogen” are supplied to the anode and the cathode, respectively, [“supplied with droplets+hydrogen/air and kept for 5 days+vacuum activation”], the initial activation further increases (e.g., the initial voltage increases from 0.51 V to 0.56 V and 0.58 Vat 1.2 A/cm²) when compared with the case where “droplets+hydrogen” are supplied and stored for a day as shown in FIG. 2, or the case in which the simple vacuum activation process is used.

When the droplet-containing air and hydrogen is supplied to the anode and the cathode, oxides of Ca, Pt, etc. are reduced, and the droplets easily penetrate into the membrane and binder due to the vacuum created in the fuel cell stack by the crossover of hydrogen and oxygen during storage, thus improving the wetting properties, resulting in acceleration of the activation process.

Accordingly, when the droplet-containing hydrogen is supplied to the cathode of the fuel cell stack or when the drop-containing air and hydrogen is supplied to the anode and the cathode of the fuel cell stack, respectively, and the resulting fuel cell stack is sealed and stored at room temperature, the oxides (PtOH, PtOₓ, etc.) on the surface of Pt and Ca are reduced [Surface Oxidation State Change, b(Tafel Constant (mV decade⁻¹) decrease], and thus the pre-activation may be achieved. Moreover, the ionic resistance (Ωcm²) may be reduced in advance of the pre-activation process by the hydration of the membrane and binder due to the vacuum created in the fuel cell stack.

Comparison of the activation effects in various cases through experiments found that a desired activation effect could be achieved when the hydrogen is supplied to the fuel cell stack according to the techniques herein.

In the experiments, the droplet-containing air, dry hydrogen, droplet-containing hydrogen, and droplet-containing air and hydrogen were supplied to fuel cell sub-stacks, respectively, depending on each experiment. FIG. 4 shows the results where the droplet-containing air was supplied to the anode and the cathode of the fuel cell stack, and FIG. 5 shows the results where the dry hydrogen was supplied to the anode and the cathode of the fuel cell stack.

When comparing the results shown in FIGS. 4 and 5 with those of FIGS. 2 and 3, the activation effect was not observed when the droplet-containing air was supplied to the anode and the cathode of the fuel cell stack, and the activation effect was relatively minor when the dry hydrogen was supplied to the anode and the cathode of the fuel cell stack. On the contrary, when the droplet-containing hydrogen was supplied to the cathode and when the droplet-containing air and hydrogen was supplied to the anode and the cathode, respectively, a sufficient activation effect was achieved and, in particular, when the droplet-containing air and hydrogen was supplied to the anode and the cathode of the fuel cell stack, respectively, and the resulting fuel cell stack was sealed and stored, the activation effect was most significant.

As described above, according to the pre-activation method for the fuel cell stack of the present invention, it may be possible to reduce the processing time and the amount of hydrogen consumed in the regular activation process for a 100% activation of the fuel cell stack by performing the pretreatment (i.e., the pre-activation process), in which the droplet-containing hydrogen may be supplied to the anode and the cathode of the fuel cell stack and the resulting fuel cell stack may be sealed and stored at room temperature, prior to the regular activation process for the fuel cell stack.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

what is claimed is:

1. A method, comprising:
injecting humidified hydrogen into an inlet manifold of an assembled fuel cell stack;
sealing the fuel cell stack; and
storing the resulting fuel cell stack for a period of time to pre-activate the fuel cell stack.

2. The method of claim 1, wherein the humidified hydrogen is injected into a cathode inlet manifold or an anode inlet manifold of the fuel cell stack so that the humidified hydrogen is supplied to the cathode or anode, respectively.

3. The method of claim 1, wherein the period of time is a day.

4. The method of claim 1, wherein the fuel cell stack is stored at room temperature.

5. The method of claim 1, further comprising:
activating the fuel cell stack to achieve 100% activation of the fuel cell stack.

6. A method, comprising:
injecting humidified air and humidified hydrogen into an anode inlet manifold and a cathode inlet manifold of an assembled fuel cell stack so that the humidified air and humidified hydrogen are supplied to an anode and a cathode of the fuel cell stack, respectively;
sealing the fuel cell stack; and
storing the fuel cell stack for a period of time to pre-activate the fuel cell stack.

7. The method of claim 6, wherein the period of time is about 5 days.

8. The method of claim 6, wherein the fuel cell stack is stored at room temperature.

9. The method of claim 6, further comprising:
activating the fuel cell stack to achieve 100% activation of the fuel cell stack.
